(19) United States
(12) Patent Application Publication
(10) Pub. No.: US 2011/0029896 A1
(43) Pub. Date: Feb. 3, 2011

(54) SYSTEM AND METHOD FOR CONTROLLING MULTIPLE COMPUTERS

(75) Inventor: Ching-Wei Cheng, Keelung (TW)

Correspondence Address: ROGER H. CHU, 19499 ERIC DRIVE, SARATOGA, CA, 95070, US

(73) Assignee: ACTION STAR ENTERPRISE CO., LTD., Sijhih, (TW)

(21) Appl. No.: 12/533,121

(22) Filed: Jul. 31, 2009

(51) Int. Cl. G06F 3/048; G06F 13/00

(52) U.S. Cl. 715/754; 710/73

(57) ABSTRACT

A system for controlling multiple computers comprising a first host computer coupled to a first keyboard, a first cursor control device and a first display screen with a first display boundary; a second host computer coupled to a second keyboard, a second cursor control device and a second display screen with a second display boundary; and a switching unit having a switch coupled between the first host computer and the second host computer; wherein a pointer controlled by the first cursor control device is located within the first display screen with the first display boundary associated the first host computer; wherein the switching unit detects the first pointer controlled by the first cursor control device moving out of the first display boundary of the first display screen after the switch is activated, the second host computer associated with the second display screen is controlled by the first keyboard and the first cursor control device through the switching unit and the first host computer.

### BACKGROUND OF THE INVENTION

(a) Field of the Invention

The present invention relates to a system for controlling multiple computers, and more particularly, to a system for enabling a single user to control multiple computers and associated display screens by way of a single cursor control device and keyboard combination.

(b) Description of the Prior Art

There exist devices for interconnecting a single computer to multiple computers. For example, a keyboard/video/mouse (KVM) switch is a device that is generally connected to multiple computers in order to enable a single keyboard, video monitor and mouse to control each of the connected computers. In this way, a user may have access to multiple computers without having to invest in corresponding keyboards, monitors, and mice for each of the computers. When the user accesses a computer connected to the KVM switch, video signals are routed from the computer, processed, and displayed on the single video monitor.

U.S. Pat. No. 7,240,111, the contents of which are hereby incorporated by reference, discloses a KVM switching device for interconnecting a single user console having user interface devices to plurality of host computers. The KVM switching device manages the video signals transmitted from each of the plurality of host computers for simultaneously displaying video signals from at least two of the plurality of host computers on the user console video display unit. The KVM switching device includes a scaling module and a cropping module. The scaling module proportionally reduces the size of the host computer windows so that more than one host computer window may be visible at a given time. These scaled windows may be made larger or smaller according to the preference of the user. The cropping module removes portions of the host computer windows that cannot be seen due to any overlapping between windows.

However, for a user (ex., a security analyst) needing to monitor many computer windows speaking, displaying all the host computer windows on the user console video display unit will be scaled down the windows boundary due to the user difficult to monitor all the computer windows simultaneously.

It is desirable, therefore, to provide a system that has an intuitive user interface to allow for easy interaction with one or more computers connected and allow for enabling a single user to control multiple computers and associated display screens by way of a single cursor control device and keyboard combination.

### SUMMARY OF THE INVENTION

It is an object of the present invention to enable a single user to control plurality of host computers and associated display screens by way of a single cursor control device and keyboard combination.

According to a preferred embodiment, the present invention provides a system for controlling multiple computers comprising a first host computer coupled to a first keyboard, a first cursor control device and a first display screen with a first display boundary; a second host computer coupled to a second keyboard, a second cursor control device and a second display screen with a second display boundary; and a switching unit having a switch coupled between the first host computer and the second host computer; wherein a pointer controlled by the first cursor control device is located within the first display screen with the first display boundary associated the first host computer; wherein the switching unit detects the first pointer controlled by the first cursor control device moving out of the first display boundary of the first display screen after the switch is activated within a particular time period, the second host computer associated with the second display screen is controlled by the first keyboard and the first cursor control device through the switching unit and the first host computer.

According to another embodiment, the present invention provides a method for controlling multiple computers comprising following steps: providing a first host computer coupled to a first keyboard, a first cursor control device and a first display screen with a first display boundary; providing a second host computer coupled to a second keyboard, a second cursor control device and a second display screen with a second display boundary; providing a switching unit having a switch coupled between the first host computer and the second host computer; providing a pointer controlled by the first cursor control device and located within the first display screen with the first display boundary associated the first host computer; activating the switch; measuring the first display boundary of the first display screen; detecting if the first pointer controlled by the first cursor control device moving out of the first display boundary of the first display screen within a particular time period after the switch activated; and controlling the second host computer associated with the second display screen by the first keyboard and the first cursor control device through the switching unit and the first host computer.

The details and technology of the present invention are described below with reference to the accompanying drawings:

### BRIEF DESCRIPTION OF THE DRAWINGS

FIG. 1 is a diagram showing an exemplary system according to the invention.

FIG. 2 is an inward appearance diagram of the switching unit according to the invention.

FIG. 3 is a flowchart for operation according to the invention.

### DETAILED DESCRIPTION OF THE PREFERRED EMBODIMENTS

The present invention is similar to a KM (keyboard mouse) switching system for enabling a single user to control multiple computers and associated display screens by way of a single cursor control device and keyboard combination. The concept is used in the system and method of present invention.

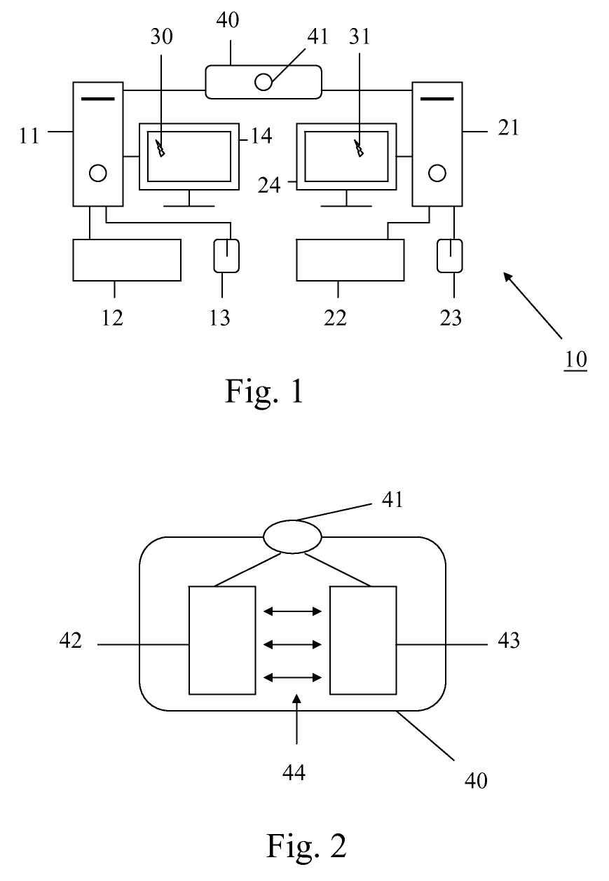

As shown in FIG. 1, the system 10 for controlling multiple computers comprises a plurality host computers (for example, a first host computer 11, a second host computer 21) and a switching unit 40 with a switch 41. As the first host computer 11 being booted, BIOS (basic input output system) of the first host computer 11 may detect if there is an input device such as keyboard and cursor control device coupled to the first host computer 11. If no, the first host computer 11 will not be booted. So does the second host computer 21. For booting the first host computer 11 and the second host computer 21 normally, the first host computer 11 is coupled to a first keyboard 12, a first cursor control device 13 and a first display screen 14 with a first display boundary and the second host computer 21 is coupled to a second keyboard 22, a second cursor control device 23 and a second display screen 24 with a second display boundary. The switching unit 40 is coupled between the first host computer 11 and the second host computer 23 and a switch 41 is disposed on the switching unit 40. Moreover, the first and second keyboard 12, 22 and the first and second cursor control device 13, 23 each has an USB connector for connecting to the associated host computers.

After the first host computer 11 being booted, a first pointer 30 controlled by the first cursor control device 13 is located within the first display screen 14 with the first display boundary associated the first host computer 11. Also, after the second host computer 21 being booted, a second pointer 31 controlled by the second cursor control device 23 is located within the second display screen 24 with the second display boundary associated the first host computer 21. A user can monitor the first display screen 14 and the second display screen 24 simultaneously and can control the first host computer 11 by the first keyboard 12 and the first pointer 30 through the first cursor control device 13 and control the second host computer 21 by the second keyboard 22 and the second pointer 31 through second cursor control device 23.

For a user (EX. a security analyst) speaking, while the user controls the first host computer 11 through the first keyboard 12, the first cursor control device 13 and the first display screen 14, the user can also monitor the second display screen 24. If messages on the second display screen 24 render the user needing to control the second host computer 21, the user has to move his/her body to a position associated to the second keyboard 22, second cursor control device 23 and second display screen 24 and control the second host computer 21 through the second keyboard 22, second cursor control device 23. However, it's not convenient. Now, the user can activate the switch 41 disposed on the switching unit 40 for rendering the switching unit 41 measuring the first display boundary of the first display screen 14 and detecting if the first pointer 30 controlled by the first cursor control device 13 moving out of the first display boundary of the first display screen 14 or not within a particular time period, for example, 2 seconds. After 2 seconds of the switch 41 activated, the user should activate the switch 41 again to determine the control of the first computer 11 or the second computer by the first pointer 30 and the first keyboard 12 for avoiding the switch 41 mis-activated.

Within a particular time period after the switch 41 is activated, if the first pointer 30 is moved within the first display boundary of the first display screen 14, the first host computer 11 is still controlled by the user. If the first pointer 30 is moved out of the first display boundary of the first display screen 14, the second host computer 21 is controlled by the first keyboard 12 and the first cursor control device 13 through the switching unit 40. It's quite convenient for the user.

The switching unit 40 stops to detect the first pointer 30 controlled by the first cursor control device 13 being moved out of the first display boundary of the first display screen 14 after a particular time period, for example, 5 seconds. If the first pointer 30 is moved out of the first display boundary of the first display screen 14, the second host computer 21 is controlled by the first keyboard 12 and the first cursor control device 13 (pointer 31) through the switching unit 40. The switching unit 40 also stops to detect the first pointer 31 controlled by the first cursor control device 13 being moved out of the second display boundary of the second display screen 24 after the switching. On the other words, the boundary detecting will be stopped after the second host computer 21 is switched to be controlled by the first keyboard 12 and the first cursor control device 13 until the switch 41 activated again. If the user now wants to control the first host computer 11 by the first keyboard 12 and the first cursor control device 13, the user should activate the switch 41 again and moving the second pointer 31 out of the second display boundary of the second display screen 24 for switching to control the first host computer 11.

As shown in FIG. 2, the switching unit 40 comprises a switch 41, a first human interface device (HID) 42 coupled to the first host computer 11, a second human interface device (HID) 43 coupled to the second host computer and a bus unit 44 coupled between the first human interface device (HID) 42 and the second human interface device (HID) 43. The bus unit 44 buffers signals transmitted between the first human interface device (HID) 42 and the second human interface device (HID) 43. The first human interface device (HID) 42 and second human interface device (HID) 43 has a transmitting port with USB standard for adapting to the associated host computers.

As the switch activated, the first human interface device (HID) 42 measures the first display boundary of the first display screen 14 and detects the first pointer 30 controlled by the first cursor control device 13 moving out of the first display boundary of the first display screen 14 or not. If the first pointer 30 controlled by the first cursor control device 13 moving out of the first display boundary of the first display screen 14, the second host computer 21 is controlled by the first keyboard 12 and the first cursor control device 13 through the first host computer, the first human interface device (HID) 42, the bus unit 44 and the second human interface device (HID) 43.

Since the second host computer 21 is controlled by the first keyboard 12 and the first cursor control device 13 and the switch now is activated, the second human interface device (HID) 43 measures the second display boundary of the second display screen 24 and detects the second pointer 31 (shown in FIG. 1) controlled by the first cursor control device 13 moving out of the second display boundary of the second display screen 24 or not. If the second pointer 31 (shown in FIG. 1) controlled by the first cursor control device 13 moving out of the second display boundary of the second display screen 24, the first host computer 11 is now back to be controlled by the first keyboard 12 and the first cursor control device 13.

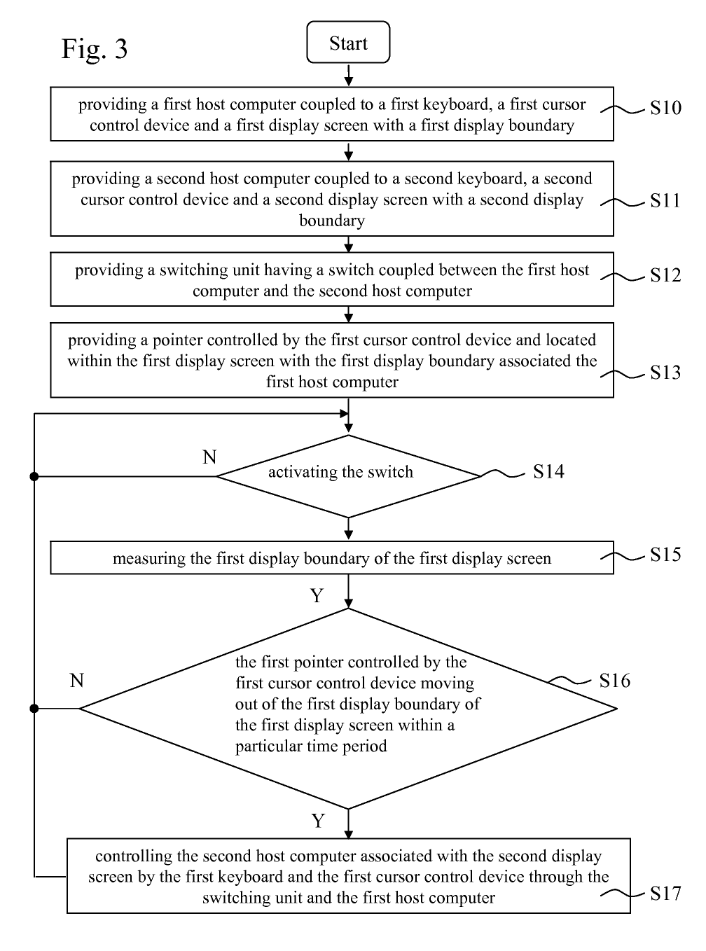

As shown in FIG. 3, the method for controlling multiple computers comprises following steps: providing a first host computer coupled to a first keyboard, a first cursor control device and a first display screen with a first display boundary (S10), providing a second host computer coupled to a second keyboard, a second cursor control device and a second display screen with a second display boundary (S11) and providing a switching unit having a switch coupled between the first host computer and the second host computer (S12). After the first host computer being booted, a first pointer controlled by the first cursor control device is generated and located within the first display screen with the first display boundary associated the first host computer (S13). Also, after the second host computer being booted, a second pointer controlled by the second cursor control device is located within the second display screen with the second display boundary associated the first host computer. A user can monitor the first display screen and the second display screen simultaneously and can control the first host computer by the first keyboard and the first pointer through the first cursor control device and control the second host computer by the second keyboard and the second pointer through second cursor control device. If messages on the second display screen render the user needing to control the second host computer, the user can activate the switch (S14) disposed on the switching unit for rendering the switching unit measuring the first display boundary of the first display screen (S15) and detecting if the first pointer controlled by the first cursor control device moving out of the first display boundary of the first display screen within a particular time period after the switch activated (S16) or not. If the first pointer is moved within the first display boundary of the first display screen, the first host computer is still controlled by the user. If the first pointer is moved out of the first display boundary of the first display screen, the second host computer is controlled by the first keyboard and the first cursor control device through the switching unit and the first host computer (S17).

Having thus described preferred embodiments of system and method that allows for controlling multiple host computers and provides for easy access to and intuitive switching between those connected computers, it should be apparent to those skilled in the art that certain advantages of the invention have been achieved. It should also be appreciated that various modifications, adaptations, and alternative embodiments thereof may be made within the scope and spirit of the present invention. The invention is further defined by the following claims.

What is claimed is:

1. A system for controlling multiple computers comprising:
a first host computer coupled to a first keyboard, a first cursor control device and a first display screen with a first display boundary;
a second host computer coupled to a second keyboard, a second cursor control device and a second display screen with a second display boundary; and
a switching unit having a switch coupled between the first host computer and the second host computer;
wherein a pointer controlled by the first cursor control device is located within the first display screen with the first display boundary associated the first host computer;
wherein the switching unit detects the first pointer controlled by the first cursor control device moving out of the first display boundary of the first display screen after the switch is activated within a particular time period, the second host computer associated with the second display screen is controlled by the first keyboard and the first cursor control device through the switching unit and the first host computer.

2. The system as defined in claim 1, wherein the first and second keyboard and the first and second cursor control device each has an USB connector.

3. The system as defined in claim 1, wherein the switching unit further comprises a first human interface device coupled to the first host computer and a second human interface device coupled to the second host computer and a bus unit coupled between the first human interface device and the second human interface device.

4. The system as defined in claim 3, wherein the first and second human interface device each has a transmitting port with USB standard.

5. The system as defined in claim 1, wherein the switching unit stops to detect if the first pointer controlled by the first cursor control device not being moved out of the first display boundary of the first display screen after a particular time period.

6. The system as defined in claim 1, wherein the switching unit stops to detect after the second host computer being switched to be controlled by the first keyboard and the first cursor control device.

7. A method for controlling multiple computers comprising following steps:
providing a first host computer coupled to a first keyboard, a first cursor control device and a first display screen with a first display boundary;
providing a second host computer coupled to a second keyboard, a second cursor control device and a second display screen with a second display boundary;
providing a switching unit having a switch coupled between the first host computer and the second host computer;
providing a pointer controlled by the first cursor control device and located within the first display screen with the first display boundary associated the first host computer;
activating the switch;
measuring the first display boundary of the first display screen;
detecting if the first pointer controlled by the first cursor control device moving out of the first display boundary of the first display screen within a particular time period after the switch activated; and
controlling the second host computer associated with the second display screen by the first keyboard and the first cursor control device through the switching unit and the first host computer.

8. The method as defined in claim 7, wherein the first and second keyboard and the first and second cursor control device each has an USB connector.

9. The method as defined in claim 7, wherein the switching unit further comprises a first human interface device coupled to the first host computer and a second human interface device coupled to the second host computer and a bus unit coupled between the first human interface device and the second human interface device.

10. The method as defined in claim 9, wherein the first and second human interface device each has a transmitting port with USB standard.

11. The method as defined in claim 7, further comprising the step of stopping the detecting of the switching unit if the first pointer controlled by the first cursor control device not being moved out of the first display boundary of the first display screen after a particular time period.

12. The method as defined in claim 7, further comprising the step of stopping the detecting of the switching unit after the second host computer being switched to be controlled by the first keyboard and the first cursor control device.
